(19) United States
(12) Patent Application Publication
(10) Pub. No.: US 2019/0135986 A1
(43) Pub. Date: May 9, 2019

(54) Polyoxymethylene and Siloxane Copolymers and Process For Making Same

(71) Applicant: Celanese Sales Germany GmbH, Sulzbach (DE)

(72) Inventors: André Hebel, Sprendlingen (DE); Nicolai Papke, Mainz-Kastel (DE)

(21) Appl. No.: 16/183,160

(22) Filed: Nov. 7, 2018

Related U.S. Application Data
(60) Provisional application No. 62/582,706, filed on Nov. 7, 2017.

(51) Int. Cl. C08G 77/46

(52) U.S. Cl. CPC C08G 77/46; C08G 77/70

(57) ABSTRACT

Long chain branched polyoxymethylene-polydimethylsiloxane copolymers are described. The copolymers have excellent impact properties, shear thinning and slip wear properties in comparison to a polyoxymethylene polymer not containing polydimethylsiloxane groups.

### RELATED APPLICATIONS

The present application is based upon and claims priority to U.S. Provisional Patent Application Ser. No. 62/582,706, filed on Nov. 7, 2017, which is incorporated herein by reference.

### BACKGROUND

Polyacetal polymers, which are commonly referred to as polyoxymethylenes (POMs), have become established as exceptionally useful engineering materials in a variety of applications. POMs for instance, are widely used in constructing molded parts, such as parts for use in the automotive industry and the electrical industry. POMs, for instance, have excellent mechanical properties, fatigue resistance, abrasion resistance, chemical resistance, and moldability.

In the past, various attempts have been made in order to improve the properties of polyoxymethylene polymers by blending the polymers with various additives. For example, in the past, polyoxymethylene polymers have been combined with tribological additives for producing polymer compositions and polymer articles well suited for use in applications where the article is in moving contact with other articles. Tribological additives that have been proposed in the past include, for instance, silicones, polysiloxanes, waxes, and the like. The tribological additives can reduce the coefficient of friction of the polymer and can make the polymer more resistant to wear.

In order to increase the impact resistance of polyoxymethylene polymers, the polymers have also been combined in the past with various impact modifiers. Impact modifiers that have been used in the past include, for instance, thermoplastic elastomers and core and shell impact modifiers. The impact modifiers increase the impact resistance of the polymers.

Although combining additives with polyoxymethylene polymers can provide polymer compositions and polymer articles with an excellent balance of properties, improvements are still needed. For example, a need exists for a method of chemically modifying polyoxymethylene polymers for improving the inherent properties of the polymers. A need also exists for chemically modified polyoxymethylene polymers that have an improved balance of properties.

### SUMMARY

In general, the present disclosure is directed to polyoxymethylene polymers that have been chemically modified with a siloxane to improve at least one property of the polymer. For example, in one embodiment, the present disclosure is directed to a branched polyoxymethylene-polydimethylsiloxane copolymer having excellent impact strength properties and shear thinning properties in combination with excellent slip wear properties. Of particular advantage, polymers can be made in accordance with the present disclosure that have a relatively low melt volume index while having excellent shear thinning.

In one embodiment, the present disclosure is directed to a polyoxymethylene polymer composition comprising a polyoxymethylene copolymer having the following structure(s):

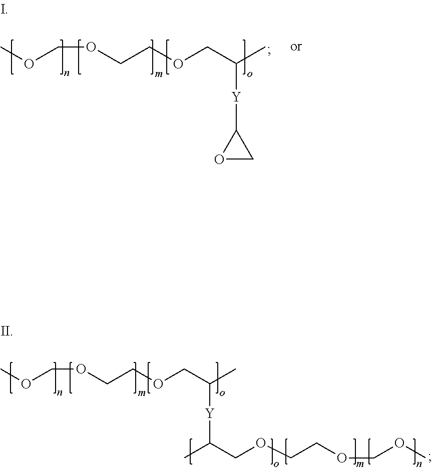

III. or mixtures of I and II
   wherein m is from 2 to 10, n is from 5 to 2,500, and o is from 1 to 150, and wherein Y has the following structure:

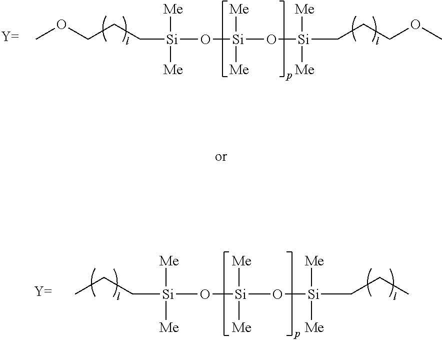

and wherein l is from 1 to 100 and p is greater than m and is from 10 to 1,000, such as from 30 to 500.

In one embodiment, the polyoxymethylene polymer composition includes a combination of a polymer made according to Formula I in combination with a polymer made according to Formula II. The polyoxymethylene copolymer of Formula I may be present in an amount greater than the polyoxymethylene copolymer of Formula II. For example, the polyoxymethylene copolymer of Formula I can be present in the composition in an amount greater than about 60% by weight, such as in an amount greater than about 70% by weight, such as in an amount greater than about 80% by weight.

Polyoxymethylene polymer compositions as defined above can have an excellent balance of properties. For instance, the polyoxymethylene polymer composition can exhibit a dynamic coefficient of friction against a polyoxymethylene polymer reference material of less than about 0.5, such as less than about 0.35, such as less than about 0.30, such as less than about 0.25, such as less than about 0.20, such as less than about 0.15, such as less than about 0.12, such as less than about 0.1, such as less than about 0.08, when tested according to VDA Test 230-206 at a force of 30 N, a velocity of 8 mm/s and for a time of 45 minutes. In addition, the polyoxymethylene polymer composition can exhibit a wear according to VDA Test 230-206 of less than about 2.0 mm, such as less than about 1.5 mm, such as less than about 1.25 mm, such as less than about 1.0 mm, such as less than about 0.5 mm, such as less than about 0.2 mm, such as less than about 0.1 mm, such as less than about 0.08 mm.

In addition to having excellent slip wear properties, the polyoxymethylene polymer composition can also have excellent impact resistance properties. For instance, the polyoxymethylene polymer composition can exhibit a Charpy notched impact strength at −30° C. of greater than about 5 kJ/m², such as greater than about 7 kJ/m², such as greater than about 10 kJ/m², such as greater than about 12 kJ/m², such as greater than about 15 kJ/m² when tested according to ISO Test 179-1/1eA.

The polyoxymethylene polymer composition can generally have a melt volume flow rate of less than about 10 ml/10 min, such as less than about 5 ml/10 min, such as less than about 2.5 ml/10 min, such as less than about 1 ml/10 min, when tested according to ISO Test 1133 at 190° C. and at a load of 2.16 kg. In addition, the polyoxymethylene polymer composition can have an induction period at its cloud point of less than 5 minutes, such as less than 2 minutes, such as less than 20 seconds.

The present disclosure is also directed to a process for producing a polyoxymethylene polymer composition having the chemical structures shown above. The process can include reacting a monomer comprising trioxane with a α,ω-epoxy terminated polydimethylsiloxane in the presence of an initiator. The initiator, in one embodiment, may comprise an acid that is boron-free. A polyoxymethylene copolymer is formed containing polydimethylsiloxane units. In one embodiment, a further monomer may be present during the reaction. The further monomer may comprise, for instance, dioxolane.

The α,ω-epoxy terminated polydimethylsiloxane monomers may generally have the following structures:

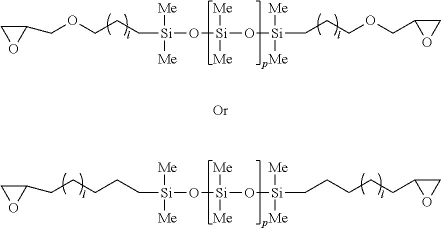

wherein l is from 1 to 100, such as 1 to 30, and p is from 10 to 1,000, such as from 30 to 500, such as from 40 to 250.

In one embodiment, an additional siloxane monomer may be present. The resulting polymer may comprise a crosslinked long chain polyoxymethylene and polydimethylsiloxane block copolymer.

In one embodiment, the polymer composition of the present disclosure can be combined with an impact modifier. The impact modifier may comprise a thermoplastic elastomer, such as a thermoplastic polyurethane elastomer. In addition, a coupling agent can be present, such as an isocyanate coupling agent.

In yet another embodiment, the polyoxymethylene polymer composition may be combined with glass fibers. The glass fibers may be present in an amount from about 2% to about 50% by weight, such as in an amount from about 5% to about 45% by weight. In addition to glass fibers, the composition may further contain a coupling agent, such as an isocyanate coupling agent.

Other features and aspects of the present disclosure are discussed in greater detail below.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to polyoxymethylene copolymers that include siloxane, particularly polydimethylsiloxane groups incorporated into the polymer. The present disclosure is also directed to a process for producing the polymers. The polyoxymethylene and siloxane copolymers made in accordance with the present disclosure can be used alone or in conjunction with other thermoplastic polymers. The branched polyoxymethylene and siloxane copolymers can be constructed to have various different desired properties. The copolymers, for instance, can be formulated so as to have a relatively high molecular weight and a relatively low melt flow index. Even at high molecular weights, the polymer exhibit excellent shear-thinning properties. For instance, copolymers made according to the present disclosure have significantly improved shear thinning and impact strength resistance in relation to similar polyoxymethylene copolymers not containing siloxane groups.

In one embodiment, the present disclosure is directed to a branched polyoxymethylene-polydialkylsiloxane block copolymer. The composition can contain a single branched block copolymer or can contain a branched block copolymer with a linear or unbranched block copolymer. For example, in one embodiment, the polyoxymethylene polymer composition can be defined by the following structures:

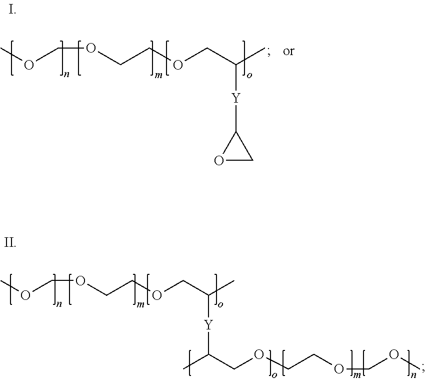

III. or mixtures of I and II
   In the above chemical formulas, m is generally greater than about 2, such as greater than about 3, such as greater than about 4, such as greater than about 5 and generally less than about 10, such as less than about 8, such as less than about 7. In the above chemical structures, n is generally greater than about 5, such as greater than about 20, such as greater than about 30, such as greater than about 40, such as greater than about 50, such as greater than about 60, such as greater than about 70, such as greater than about 100, such as greater than about 200, such as greater than about 300, such as greater than about 400 and generally less than about 1,500, such as less than about 1,300, such as less than about 1,000, such as less than about 800, such as less than about 600, such as less than about 500. In the above chemical formulas, o is generally greater than about 1, such as greater than about 5, such as greater than about 20, such as greater than about 50, such as greater than about 100 and generally less than about 500, such as less than about 250, such as less than about 200, such as less than about 175, such as less than about 150.

In the above chemical structures, Y can have the following structures:

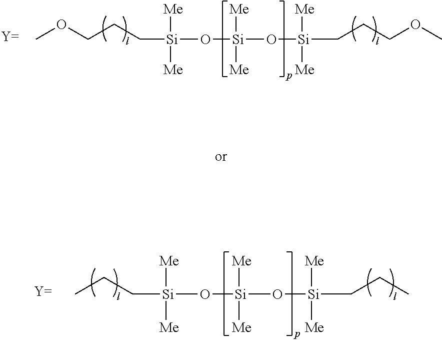

In the above chemical structures, l is generally greater than 1, such as greater than 3, such as greater than 5, such as greater than 8, such as greater than 10, such as greater than 12, such as greater than 15, such as greater than 20, such as greater than 25, such as greater than 30, such as greater than 40, such as greater than 50 and generally less than about 100, such as less than about 90, such as less than about 80, such as less than about 70. In the above structures, p is greater than m. For instance, p can be from about 10 to about 2,000, such as from about 30 to about 1000.

In one embodiment, the present disclosure is directed to a polymer composition containing both polymers having Formula I and Formula II above. In one embodiment, greater amounts of the polymer according to Formula I can be present in relation to the polymer according to Formula II.

For instance, based upon the total amount of polymers present having the structure of Formula I and the structure of Formula II, the polymer of Formula I can be present in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight. In general, the polymer according to Formula I above is present in an amount less than about 95% by weight, such as in an amount less than about 90% by weight, such as in an amount less than about 85% by weight. The above weight percentages are based upon 100 wt. % being the total amount of polymers present according to Formula I and Formula II above. In other words, the polymer having Formula I above can be present in relation to the polymer having Formula II above according to a weight ratio of from about 3:2 to about 9:1, such as from about 7:3 to about 9:1, such as from about 4:1 to about 9:1.

Polymer compositions made according to the present disclosure can have an excellent blend of properties. For instance, the polymer composition described above can have excellent slip wear properties. In particular, the polymer can exhibit a relatively low coefficient of friction and can exhibit a relatively high durability, even in applications where the polymer article made from the polymer composition is constantly in contact in a moving relationship with other components and parts.

For instance, the polymer composition of the present disclosure can have a dynamic coefficient of friction against a polyoxymethylene polymer reference surface of less than about 0.5, such as less than about 0.35, such as less than about 0.30, such as less than about 0.25, such as less than about 0.2, such as less than about 0.15, such as less than about 0.12, such as less than about 0.1, such as less than about 0.08, when tested according to VDA Test 230-206 at a force of 30 N, a velocity of 8 mm/s and for a time of 45 minutes. When tested according to VDA Test 230-206, the polymer composition can also exhibit a wear of less than about 2.5 mm, such as less than about 2.0 mm, such as less than about 1.5 mm, such as less than about 1.25 mm, such as less than about 1.0 mm, such as less than about 0.5 mm, such as less than about 0.2 mm, such as less than about 0.1 mm, such as less than about 0.08 mm.

In addition to excellent slip wear properties, polymer compositions made according to the present disclosure can also have excellent impact resistance properties, especially in comparison to conventional polyoxymethylene homopolymers and copolymers. For instance, even when tested at −30° C., the polymer composition of the present disclosure can have a Charpy notched impact strength of greater than about 5 kJ/m², such as greater than about 8 kJ/m², such as greater than about 10 kJ/m², such as greater than about 12 kJ/m², such as greater than about 15 kJ/m², such as even greater than about 20 kJ/m² when tested according to ISO Test 179-1/1eA. The notched impact strength at −30° C. of the polymer composition is generally less than about 40 kJ/m², such as less than about 30 kJ/m².

The polymer composition of the present disclosure can also have excellent shear-thinning properties. The shear-thinning properties, for instance, are much better than conventional polyoxymethylene homopolymers and copolymers. For instance, polymer compositions made according to the present disclosure can have a torque of greater than about 500 N, such as greater than about 1,000 N, such as greater than about 1,500 N, such as greater than about 2,000 N, such as greater than about 2,500 N, such as greater than about 3,000 N, such as greater than about 4,000 N. The torque is generally less than about 5,000 N when tested with DSM Micro 15.

The polyoxymethylene-polydimethylsiloxane copolymers can generally have a melting point of greater than about 160° C., such as greater than about 165° C., such as greater than about 167° C., such as greater than about 170° C. and generally less than about 180° C., such as less than about 175° C. The polyoxymethylene-polydimethylsiloxane copolymers can have an induction period at its cloud point of less than about 5 minutes, such as less than about 2 minutes, such as less than about 20 seconds.

In order to produce the branched polyoxymethylene-polydimethylsiloxane copolymers of the present disclosure, one or more polyoxymethylene monomers are combined with a siloxane monomer in the presence of an initiator or a catalyst.

In one embodiment, the siloxane monomer may comprise an α,ω-epoxy terminated polydialkylsiloxane, such as a α,ω-epoxy terminated polydimethylsiloxane. For instance, the siloxane monomer may have one of the following structures:

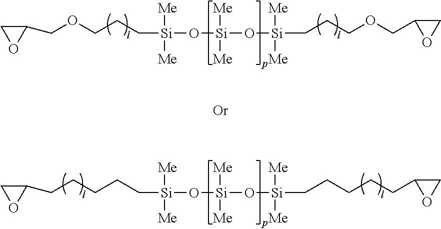

wherein l is from 1 to 100, such as 1 to 30, and p is from 10 to 1,000, such as from 30 to 500, such as from 40 to 250.

The polyoxymethylene monomer generally comprises a monomer that forms —CH₂—O— units. For instance, the polyoxymethylene monomer may comprise a cyclic acetal such as trioxane, tetraoxane, or mixtures thereof.

In one embodiment, a third monomer may be present that can form repeat units of a saturated or ethylenically unsaturated alkylene group having at least two carbon atoms or a cycloalkylene group. The monomer content of the third monomer can be greater than about 0% and up to about 50 mol %. For instance, the third monomer can be added so as to produce from about 0.01 mol % to about 20 mol %, such as from about 0.5 mol % to about 10 mol %, such as from about 1 mol % to about 5 mol % of the above repeat units. The third monomer, for instance, may comprise a cyclic ether or acetal having the following formula:

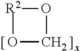

in which x is 0 or 1 and R² is a C₂-C₄-alkylene group which, if appropriate, has one or more substituents which are C₁-C₄-akyl groups, or are C₁-C₄-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers.

As explained above, the branched polyoxymethylene-polydimethylsiloxane copolymers are formed in the presence of an initiator or a catalyst. The catalyst or initiator, for instance, can be boron-free. For instance, the catalyst or initiator may comprise trifluoromethanesulfonic acid or derivatives thereof. Alternatively, the initiator may comprise a heteropoly acid.

Other catalysts that can be used include perchloric acid, methanesulfonic acid, toluenesulfonic acid and sulfuric acid, or derivatives thereof such as anhydrides or esters or any other derivatives that generate the corresponding acid under the reaction conditions. Lewis acids like arsenic pentafluoride can also be used. It is also possible to use mixtures of all the individual catalysts mentioned above.

Alternatively, the initiator or catalyst can comprise a heterogeneous catalyst. The catalyst, for instance, can be immisible in the reaction mixture. For example, the catalyst may comprise a solid catalyst. As used herein, a solid catalyst is a catalyst that includes one solid component. For instance, a catalyst may comprise an acid that is adsorbed or otherwise fixed to a solid support.

In one embodiment, the heterogeneous catalyst may comprise a Lewis or Broensted acid species dissolved in an inorganic molten salt. The molten salt may have a melting point below 200° C., such as less than about 100° C., such as less than about 30° C. The molten salt can then be immobilized or fixed onto a solid support as described above. The solid support, for instance, may be a polymer or a solid oxide. An example of an organic molten salt include ionic liquids. For instance, the ionic liquid may comprise 1-n-alkyl-3-methylimidazolium triflate. Another example is 1-n-alkyl-3-methylimidazolium chloride.

In one embodiment, the acidic compound present in the catalyst can have a pKa below 0, such as below about −1, such as below about −2, when measured in water at a temperature of 18° C. The pKa number expresses the strength of an acid and is related to the dissociation constant for the acid in an aqueous solution.

Examples of heterogeneous catalysts that may be used according to the present disclosure include the following:

(1) solid catalysts represented by acidic metal oxide combinations which can be supported onto usual carrier materials such as silica, carbon, silica-alumina combinations or alumina. These metal oxide combinations can be used as such or with inorganic or organic acid doping. Suitable examples of this class of catalysts are amorphous silica-alumina, acid clays, such as smectites, inorganic or organic acid treated clays, pillared clays, zeolites, usually in their protonic form, and metal oxides such as ZrO2-TiO2 in about 1:1 molar combination and sulfated metal oxides e.g. sulfated ZrO2. Other suitable examples of metal oxide combinations, expressed in molar ratios, are: TiO2-SiO2 1:1 ratio; and ZrO2-SiO2 1:1 ratio.

(2) several types of cation exchange resins can be used as acid catalyst to carry out the reaction. Most commonly, such resins comprise copolymers of styrene, ethylvinyl benzene and divinyl benzene functionalized so as to graft SO3H groups onto the aromatic groups. These acidic resins can be used in different physical configurations such as in gel form, in a macro-reticulated configuration or supported onto a carrier material such as silica or carbon or carbon nanotubes. Other types of resins include perfluorinated resins carrying carboxylic or sulfonic acid groups or both carboxylic and sulfonic acid groups. Known examples of such resins are: NAFION, and AMBERLYST resins. The fluorinated resins can be used as such or supported onto an inert material like silica or carbon or carbon nanotubes entrapped in a highly dispersed network of metal oxides and/or silica.

(3) heterogeneous solids, having usually a lone pair of electrons, like silica, silica-alumina combinations, alumina, zeolites, silica, activated charcoal, sand and/or silica gel can be used as support for a Broensted acid catalyst, like methane sulfonic acid or para-toluene sulfonic acid, or for a compound having a Lewis acid site, such as SbF5, to thus interact and yield strong Broensted acidity. Heterogeneous solids, like zeolites, silica, or mesoporous silica or polymers like e.g. polysiloxanes can be functionalized by chemical grafting with a Broensted acid group or a precursor therefore to thus yield acidic groups like sulfonic and/or carboxylic acids or precursors therefore. The functionalization can be introduced in various ways known in the art like: direct grafting on the solid by e.g. reaction of the SiOH groups of the silica with chlorosulfonic acid; or can be attached to the solid by means of organic spacers which can be e.g. a perfluoro alkyl silane derivative. Broensted acid functionalized silica can also be prepared via a sol gel process, leading to e.g. a thiol functionalized silica, by co-condensation of Si(OR)4 and e.g. 3-mercaptopropyl-tri-methoxy silane using either neutral or ionic templating methods with subsequent oxidation of the thiol to the corresponding sulfonic acid by e.g. H2O2. The functionalized solids can be used as is, i.e. In powder form, in the form of a zeolitic membrane, or in many other ways like in admixture with other polymers in membranes or in the form of solid extrudates or in a coating of e.g. a structural inorganic support e.g. monoliths of cordierite; and

(4) heterogeneous heteropolyacids having most commonly the formula HxPMyOz. In this formula, P stands for a central atom, typically silicon or phosphorus. Peripheral atoms surround the central atom generally in a symmetrical manner. The most common peripheral elements, M, are usually Mo or W although V, Nb, and Ta are also suitable for that purpose. The indices xyz quantify, in a known manner, the atomic proportions in the molecule and can be determined routinely. These polyacids are found, as is well known, in many crystal forms but the most common crystal form for the heterogeneous species is called the Keggin structure. Such heteropolyacids exhibit high thermal stability and are non-corrosive. The heterogeneous heteropolyacids are preferably used on supports selected from silica gel, kieselguhr, carbon, carbon nanotubes and ion-exchange resins. A preferred heterogeneous heteropolyacid herein can be represented by the formula H3PM12O40 wherein M stands for W and/or Mo. Examples of preferred PM moieties can be represented by PW12, PMo12, PW12/SiO2, PW12/carbon and SiW12.

In general, the reaction can be carried out continuously or in a batch-wise manner. The reaction can be completed very quickly yielding extremely high conversion rates. The reaction temperature can generally be from about 0° C. to about 200° C. or more, such as from about 40° C. to about 150° C. The pressure can generally be from 1-60 bar.

In order to terminate the polymerization, the reaction mixture, which still comprises unconverted monomers, such as trioxane, alongside polymer, is brought into contact with deactivators. These can be added in bulk form or a form diluted with an inert aprotic solvent to the polymerization mixture. The result is rapid and complete deactivation of the active chain ends.

Deactivators that can be used are those compounds which react with the active chain ends in such a way as to terminate the polymerization reaction. Examples are the organic bases triethylamine or melamine, and also the inorganic bases potassium carbonate or sodium acetate. It is also possible to use very weak organic bases, such as carboxamides, e.g. dimethylformamide. Tertiary bases are particularly preferred, examples being triethylamine and hexamethylmelamine.

The concentrations used of the bases are from 1 ppm to 1% by weight, based on the polymerization material. Concentrations of from 10 ppm to 5000 ppm are preferred.

Typical deactivation temperatures vary in the range from 125° C. to 180° C., particularly preferably in the range from 135° C. to 160° C., and very particularly preferably in the range from 140° C. to 150° C.

Typical deactivation pressures vary in the range from 0.5 to 150 bar, such as from 1 to 100 bar, preferably from 5 to 40 bar.

The polymerization can take place in reactors known for the preparation of POM homo- and copolymers. Typically, kneaders or extruders are used, designed to be temperature-controllable and pressure-resistant.

After deactivation, the resulting polymer or polymer mixture can be subjected to various processes to remove unstable end groups. For instance, the polymer can be exposed to elevated temperatures in order to undergo thermal hydrolysis. The liquid polymerization mixture can also be transferred into a depressurization zone in order to remove residual monomers and solvent.

Of particular advantage, branched polyoxymethylene-polydimethylsiloxane copolymers made according to the present disclosure can have a generally high melt flow rate while having a relatively high molecular weight. The molecular weight (Mn) of the resulting polymer, for instance, can be greater than about 30,000 g/mol, such as greater than about 35,000 g/mol, such as greater than about 40,000 g/mol, such as greater than about 45,000 g/mol, such as greater than about 50,000 g/mol, such as greater than about 55,000 g/mol, such as greater than about 60,000 g/mol, such as greater than about 65,000 g/mol, and generally less than about 200,000 g/mol. The molecular weight (Mw) is generally greater than about 150,000 g/mol, such as greater than about 160,000 g/mol, such as greater than about 170,000 g/mol, such as greater than about 180,000 g/mol, such as greater than about 190,000 g/mol, and generally less than about 500,000 g/mol, such as less than about 300,000 g/mol.

The branched polyoxymethylene-polydimethylsiloxane copolymers can generally have a melt volume rate of from about 0.1 ml/10 min to about 75 ml/10 min. In one embodiment, the one or more copolymers are constructed so as to have a relatively low melt volume rate. For instance, the melt volume rate can be less than about 20 ml/10 min, such as less than about 10 ml/10 min, such as less than about 8 ml/10 min, such as less than about 5 ml/10 min, such as less than about 4 ml/10 min, such as less than about 3 ml/10 min, such as less than about 2 ml/10 min, such as less than about 1 ml/10 min. The melt volume rate is determined according to ISO Test 1133 at 190° C. and at a load of 2.16 kg.

In one embodiment, the branched polyoxymethylene-polydimethylsiloxanes produced according to the present disclosure have a relatively high number of terminal hydroxyl groups. For instance, during the reaction, some of the epoxy functionalized siloxane monomers may not yield a crosslinking of the polyoxymethylene polymer backbone. Thus, remaining epoxy groups are available to react under alkaline conditions to produce terminal hydroxyl groups. For instance, the remaining epoxy groups can react under alkaline conditions in a quench, such as an aqueous methanol medium to produce the terminal hydroxyl groups. Through these reaction conditions, terminal hydroxyl groups can form not only laterally on the polyoxymethylene polymer groups but can also form as end groups on the siloxane chains. The length of the polyoxymethylene groups can be adjusted by adding a molecular weight regulator during the reaction. The molecular weight regulator may comprise, for instance, methylal or a glycol. Of particular advantage, the length of the polyoxymethylene polymer chains can be adjusted without reducing the number of lateral hydroxy groups.

For example, the resulting branched polyoxymethylene-polydimethylsiloxane copolymers can have a content of terminal hydroxyl groups of at least 5 mmol/kg, such as at least 10 mmol/kg, such as at least 15 mmol/kg, such as at least 20 mmol/kg, such as at least 25 mmol/kg, such as at least 30 mmol/kg, such as at least 35 mmol/kg, such as at least 40 mmol/kg, such as at least 45 mmol/kg, such as at least 50 mmol/kg, such as at least 55 mmol/kg, such as at least 60 mmol/kg. The amount of terminal hydroxyl groups is generally less than about 300 mmol/kg, such as less than about 200 mmol/kg. For example, the branched polyoxymethylene-polydimethylsiloxane copolymers can have terminal hydroxyl groups in at least more than about 50%, such as more than about 60%, such as more than about 70%, such as more than about 80%, such as more than about 90% of all the terminal sites on the polymer.

Incorporating significant amounts of hydroxyl groups on the branched polyoxymethylene-polydimethylsiloxane copolymers can provide various advantages and benefits. For instance, the terminal hydroxyl sites can be used as reactive sites with a coupling agent. The coupling agent can be used to couple the polymers to other materials, such as an impact modifier or to glass surfaces, such as glass fibers.

In one embodiment, in addition to using epoxy terminated polydimethylsiloxane monomers, various other siloxane monomers may be present during the reaction. Other monomers may be added, for instance, in order to increase the amount of siloxane groups that are incorporated into the polymer backbone. For example, the following siloxane monomers can also be present during the reaction:

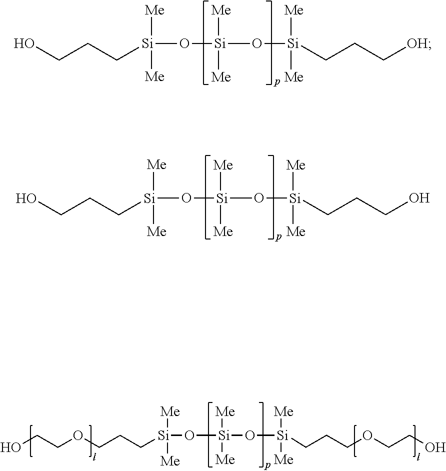

wherein p is from about 5 to about 500, such as from about 5 to about 200, such as from about 7 to about 75. I is from 1 to 100, such as 1 to 30, and p is from 10 to 1,000, such as from 30 to 500, such as from 40 to 250.

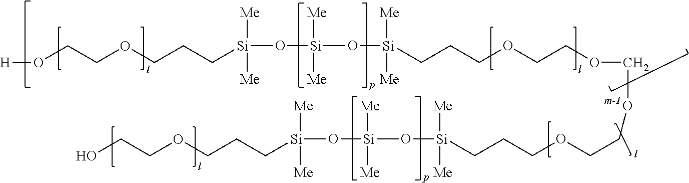

and wherein l is from about 2 to about 50, such as from about 2 to about 35, such as from about 8 to about 20; p is from about 5 to about 500, such as from about 5 to about 200, such as from about 7 to about 75; and m is from about 2 to about 10.

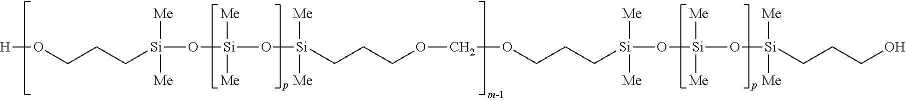

and wherein p is from about 5 to about 500, such as from about 5 to about 200, such as from about 7 to about 75; and m is from about 2 to about 10.

Once the branched polyoxymethylene-polydimethylsiloxane copolymers have been constructed, the polymers can be combined with various other additives in order to improve one or more properties.

For example, in one embodiment, a formaldehyde scavenger may be combined with the polymer. A formaldehyde scavenger is a compound that reacts and binds formaldehyde.

In general, the total amount of formaldehyde scavengers present in the composition is relatively small. For instance, the formaldehyde scavengers can be present in an amount less than about 2 percent by weight, such as from about 0.01 percent to about 2 percent by weight, such as from about 0.05 percent to about 0.5 percent by weight (which excludes other nitrogen containing compounds that may be present in the composition that are not considered formaldehyde scavengers such as waxes or hindered amines). Any suitable formaldehyde scavenger can be included into the composition including, for example, aminotriazine compounds, allantoin, hydrazides, polyamides, melamines, or mixtures thereof. In one embodiment, the nitrogen containing compound may comprise a heterocyclic compound having at least one nitrogen atom adjacent to an amino substituted carbon atom or a carbonyl group. In one specific embodiment, for instance, the nitrogen containing compound may comprise benzoguanamine.

In still other embodiments, the nitrogen containing compound may comprise a melamine modified phenol, a polyphenol, an amino acid, a nitrogen containing phosphorus compound, an acetoacetamide compound, a pyrazole compound, a triazole compound, a hemiacetal compound, other guanamines, a hydantoin, a urea including urea derivatives, and the like.

The nitrogen containing compound may comprise a low molecular weight compound or a high molecular weight compound. The nitrogen-containing compound having a low molecular weight may include, for example, an aliphatic amine (e.g., monoethanolamine, diethanolamine, and tris-(hydroxymethyl)aminomethane), an aromatic amine (e.g., an aromatic secondary or tertiary amine such as o-toludine, p-toluidine, p-phenylenediamine, o-aminobenzoic acid, p-aminobenzoic acid, ethyl o-aminobenzoate, or ethyl p-aminobenzoate), an imide compound (e.g., phthalimide, trimellitimide, and pyromellitimide), a triazole compound (e.g., benzotriazole), a tetrazole compound (e.g., an amine salt of 5,5′-bitetrazole, or a metal salt thereof), an amide compound (e.g., a polycarboxylic acid amide such as malonamide or isophthaldiamide, and p-aminobenzamide), hydrazine or a derivative thereof [e.g., an aliphatic carboxylic acid hydrazide such as hydrazine, hydrazone, a carboxylic acid hydrazide (stearic hydrazide, 12-hydroxystearic hydrazide, adipic dihydrazide, sebacic dihydrazide, or dodecane diacid dihydrazide; and an aromatic carboxylic acid hydrazide such as benzoic hydrazide, naphthoic hydrazide, isophthalic dihydrazide, terephthalic dihydrazide, naphthalenedicarboxylic dihydrazide, or benzenetricarboxylic trihydrazide)], a polyaminotriazine [e.g., guanamlne or a derivative thereof, such as guanamine, acetoguanamine, benzoguanamine, succinoguanamine, adipoguanamine, 1,3,6-tris(3,5-diamino-2,4,6-triazinyl)hexane, phthaloguanamine or CTU-guanamine, melamine or a derivative thereof (e.g., melamine, and a condensate of melamine, such as melam, melem or melon)], a salt of a polyaminotriazine compound containing melamine and a melamine derivative with an organic acid [for example, a salt with (iso)cyanuric acid (e.g., melamine cyanurate)], a salt of a polyaminotriazine compound containing melamine and a melamine derivative with an inorganic acid [e.g., a salt with boric acid such as melamine borate, and a salt with phosphoric acid such as melamine phosphate], uracil or a derivative thereof (e.g., uracil, and uridine), cytosine and a derivative thereof (e.g., cytosine, and cytidine), guanidine or a derivative thereof (e.g., a non-cyclic guanidine such as guanidine or cyanoguanidine; and a cyclic guanidine such as creatinine), urea or a derivative thereof [e.g., bluret, biurea, ethylene urea, propylene urea, acetylene urea, a derivative of acetylene urea (e.g., an alkyl-substituted compound, an aryl-substituted compound, an aralkyl-substituted compound, an acyl-substituted compound, a hydroxymethyl-substituted compound, and an alkoxymethyl-substituted compound), isobutylidene diurea, crotylidene diurea, a condensate of urea with formaldehyde, hydantoin, a substituted hydantoin derivative (for example, a mono or diC₁₋₄alkyl-substituted compound such as 1-methylhydantoin, 5-propylhydantoin or 5,5-dimethylhydantoin; an aryl-substituted compound such as 5-phenylhydantoin or 5,5-diphenylhydantoin; and an alkylaryl-substituted compound such as 5-methyl-5-phenylhydantoin), allantoin, a substituted allantoin derivative (e.g., a mono, di or triC₁₋₄alkyl-substituted compound, and an aryl-substituted compound), a metal salt of allantoin (e.g., a salt of allantoin with a metal element of the Group 3B of the Periodic Table of Elements, such as allantoin dihydroxyaluminum, allantoin monohydroxyaluminum or allantoin aluminum), a reaction product of allantoin with an aldehyde compound (e.g., an adduct of allantoin and formaldehyde), a compound of allantoin with an imidazole compound (e.g., allantoin sodium dl-pyrrolidonecarboxylate), an organic acid salt].

The composition may also contain colorants, light stabilizers, antioxidants, heat stabilizers, processing aids, and fillers.

Colorants that may be used include any desired inorganic pigments, such as titanium dioxide, ultramarine blue, cobalt blue, and other organic pigments and dyes, such as phthalocyanines, anthraquinones, and the like. Other colorants include carbon black or various other polymer-soluble dyes. The colorants can generally be present in the composition in an amount up to about 2 percent by weight.

In one embodiment, the composition may contain a nucleant. The nucleant, for instance, may increase crystallinity and may comprise an oxymethylene terpolymer. In one particular embodiment, for instance, the nucleant may comprise a terpolymer of butanediol diglycidyl ether, ethylene oxide or dioxolane, and trioxane. The nucleant can be present in the composition in an amount greater than about 0.05% by weight, such as greater than about 0.1% by weight. The nucleant may also be present in the composition in an amount less than about 2% by weight, such as in an amount less than about 1% by weight.

Still another additive that may be present in the composition is a sterically hindered phenol compound, which may serve as an antioxidant. Examples of such compounds, which are available commercially, are pentaerythrityl tetrakis[3-(3,5-di-tert-butyl-4-hydroxyphenyl)propionate] (Irganox 1010, BASF), triethylene glycol bis[3-(3-tert-butyl-4-hydroxy-5-methylphenyl)propionate] (Irganox 245, BASF), 3,3′-bis[3-(3,5-di-tert-butyl-4-hydroxyphenyl)propionohydrazide] (Irganox MD 1024, BASF), hexamethylene glycol bis[3-(3,5-di-tert-butyl-4-hydroxyphenyl)propionate] (Irganox 259, BASF), and 3,5-di-tert-butyl-4-hydroxytoluene (Lowinox BHT, Chemtura). Preference is given to Irganox 1010 and especially Irganox 245. The above compounds may be present in the composition in an amount less than about 2% by weight, such as in an amount from about 0.01% to about 1% by weight.

Light stabilizers that may be present in the composition include sterically hindered amines. Such compounds include 2,2,6,6-tetramethyl-4-piperidyl compounds, e.g., bis(2,2,6,6-tetramethyl-4-piperidyl) sebacate (Tinuvin 770, BASF) or the polymer of dimethyl succinate and 1-(2-hydroxyethyl)-4-hydroxy-2,2,6,6-tetramethyl-4-piperidine (Tinuvin 622, BASF). In one embodiment, the light stabilizer may comprise 2-(2H-benzzotriazol-2-yl) 4,6-bis(1-ethyl-1-phenyl-ethyl)phenol (Tinuvin 234). Other hindered amine light stabilizers that may be used include oligomeric compounds that are N-methylated. For instance, another example of a hindered amine light stabilizer comprises ADK STAB LA-63 light stabilizer available from Adeka Palmarole.

One or more light stabilizers may be present in the composition in an amount generally less than about 5% by weight, such as in an amount less than 4% by weight, such as in an amount less than about 2% by weight. The light stabilizers, when present, can be included in amounts greater than about 0.1% by weight, such as in amounts greater than about 0.5% by weight.

The above light stabilizers may protect the composition from ultraviolet light. In addition to the above light stabilizers, UV stabilizers or absorbers that may also be present in the composition include benzophenones or benzotriazoles.

Fillers that may be included in the composition include glass beads, wollastonite, loam, molybdenum disulfide or graphite, inorganic or organic fibers such as glass fibers, carbon fibers or aramid fibers. The glass fibers, for instance, may have a length of greater than about 3 mm, such as from 5 to about 50 mm. The composition can further include thermoplastic or thermoset polymeric additives, or elastomers such as polyethylene, polyurethane, polymethyl methacrylate, polybutadiene, polystyrene, or else graft copolymers whose core has been prepared by polymerizing 1,3-butadiene, isoprene, n-butyl acrylate, ethylhexyl acrylate, or mixtures of these, and whose shell has been prepared by polymerizing styrene, acrylonitrile or (meth)acrylates.

In one embodiment, especially when the branched polyoxymethylene-polydimethylsiloxane copolymers contain relatively great amounts of lateral hydroxyl groups, the copolymers can be combined with an impact modifier and a coupling agent. The impact modifier may comprise a thermoplastic elastomer. Thermoplastic elastomers are materials with both thermoplastic and elastomeric properties. Thermoplastic elastomers include styrenic block copolymers, polyolefin blends referred to as thermoplastic olefin elastomers, elastomeric alloys, thermoplastic polyurethanes, thermoplastic copolyesters, and thermoplastic polyamides.

Thermoplastic elastomers well suited for use in the present disclosure are polyester elastomers (TPE-E), thermoplastic polyimide elastomers (TPE-A) and in particular thermoplastic polyurethane elastomers (TPE-U). The above thermoplastic elastomers have active hydrogen atoms which can be reacted with the coupling reagents and/or the polyoxymethylene polymer. Examples of such groups are urethane groups, amido groups, amino groups or hydroxyl groups. For instance, terminal polyester diol flexible segments of thermoplastic polyurethane elastomers have hydrogen atoms which can react, for example, with isocyanate groups.

In one particular embodiment, a thermoplastic polyurethane elastomer is used as the impact modifier either alone or in combination with other impact modifiers. The thermoplastic polyurethane elastomer, for instance, may have a soft segment of a long-chain diol and a hard segment derived from a diisocyanate and a chain extender. In one embodiment, the polyurethane elastomer is a polyester type prepared by reacting a long-chain diol with a diisocyanate to produce a polyurethane prepolymer having isocyanate end groups, followed by chain extension of the prepolymer with a diol chain extender. Representative long-chain diols are polyester diols such as polybutylene adipate)diol, polyethylene adipate)diol and poly(ε-caprolactone)diol; and polyether diols such as poly(tetramethylene ether)glycol, polypropylene oxide)glycol and polyethylene oxide)glycol. Suitable diisocyanates include 4,4′-methylenebis(phenyl isocyanate), 2,4-toluene diisocyanate, 1,6-hexamethylene diisocyanate and 4,4′-methylenebis-(cycloxylisocyanate). Suitable chain extenders are C₂-C₆ aliphatic diols such as ethylene glycol, 1,4-butanediol, 1,6-hexanediol and neopentyl glycol. One example of a thermoplastic polyurethane is characterized as essentially poly(adipic acid-co-butylene glycol-co-diphenylmethane diisocyanate).

The amount of impact modifier contained in the polymer composition can vary depending on many factors. The amount of impact modifier present in the composition may depend, for instance, on the amount of coupling agent present and the amount of terminal hydroxyl groups present on the polymer. In general, one or more impact modifiers may be present in the composition in an amount greater than about 5% by weight, such as in an amount greater than about 10% by weight. The impact modifier is generally present in an amount less than 30% by weight, such as in an amount less than about 25% by weight, such as in an amount up to about 18% by weight.

The coupling agent present in the polymer composition comprises a coupling agent capable of coupling the impact modifier to the polyoxymethylene polymer. In order to form bridging groups between the polyoxymethylene polymer and the impact modifier, a wide range of polyfunctional, such as bifunctional or trifunctional coupling agents, may be used. The coupling agent may be capable of forming covalent bonds with the terminal hydroxyl groups on the polymer and with active hydrogen atoms on the impact modifier. In this manner, the impact modifier becomes coupled to the polyoxymethylene through covalent bonds.

In one embodiment, the coupling agent comprises a diisocyanate, such as an aliphatic, cycloaliphatic and/or aromatic diisocyanate. The coupling agent may be in the form of an oligomer, such as a trimer or a dimer.

In one embodiment, the coupling agent comprises a diisocyanate or a triisocyanate which is selected from 2,2′-, 2,4′-, and 4,4′-diphenylmethane diisocyanate (MDI); 3,3′-dimethyl-4,4′-biphenylene diisocyanate (TODD; toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl)dicyclohexane; 2,4′-bis(isocyanatomethyl)dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis(isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3-′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

In one embodiment, an aromatic polyisocyanate is used, such as 4,4′-diphenylmethane diisocyanate (MDI).

The polymer composition generally contains the coupling agent in an amount from about 0.1% to about 10% by weight. In one embodiment, for instance, the coupling agent is present in an amount greater than about 1% by weight, such as in an amount greater than 2% by weight. In one particular embodiment, the coupling agent is present in an amount from about 0.2% to about 5% by weight. To ensure that the impact modifier has been completely coupled to the polyoxymethylene polymer, in one embodiment, the coupling agent can be added to the polymer composition in molar excess amounts when comparing the reactive groups on the coupling agent with the amount of terminal hydroxyl groups on the polyoxymethylene polymer.

In another embodiment, one or more of the above coupling agents in the above amounts can be present in the polymer composition in combination with a glass reinforcing material. The glass reinforcing material, for instance, may include a sizing agent that attaches to the coupling agent. In one embodiment, the glass reinforcing material may comprise glass fibers. The glass fibers can be present in the polymer composition in an amount generally greater than 1% by weight, such as in an amount greater than about 5% by weight, such as in an amount greater than about 10% by weight, such as in an amount greater than about 15% by weight, such as in an amount greater than about 20% by weight, such as in an amount greater than about 25% by weight. Glass fibers are generally present in an amount less than about 50% by weight, such as in an amount less than about 40% by weight, such as in an amount less than about 30% by weight, such as in an amount less than about 25% by weight.

Shaping processes for forming articles of the composition can include, without limitation, extrusion, injection molding, blow-molding, compression molding, hot-stamping, pultrusion, and so forth. Shaped articles that may be formed may include structural and non-structural shaped parts. For instance, automotive components such as fuel tanks, and fuel caps, fuel filler necks, fuel sender unit components (e.g. flanges or swirl pot), fuel pumps, fuel rails, turn signal and light shifters, power window components, door lock system components, and so forth can be formed from the polyoxymethylene composition.

The branched polyoxymethylene-polydimethylsiloxane copolymer can be shaped according to an injection molding process to form products that can have a relatively intricate or complicated shape. For example, products that can be formed from the polyoxymethylene composition that may be formed according to an injection molding process can include components such as, without limitation, mechanical gears, sliding and guiding elements, housing parts, springs, chains, screws, nuts, fan wheels, pump parts, valve bodies, hardware such as locks, handles, and hinges, zippers, and so forth.

The branched polyoxymethylene-polydimethylsiloxane copolymer can also be utilized in electrical applications, for instance in forming insulators, bobbins, connectors, and parts for electronic devices such as televisions, telephones, etc. Medical devices such as injection pens and metered dose inhalers can be formed of the polyoxymethylene composition as well as a variety of sporting goods equipment (e.g., paintball accessories and airsoft guns) and household appliances (e.g., coffee makers and knife handles).

The present disclosure may be better understood with reference to the following example.

### Example

In the following example, long-chain branched polyoxymethylene-polydimethylsiloxanes were produced according to the present disclosure using Bis-epoxy terminated siloxane monomers.

The polymerization trials were performed in a Teflon beaker. 500 g Trioxane was copolymerized at 100° C. with Dioxolane and a α,ω-Epoxy terminated Polydimethylsiloxane according to Table 1. The polymerization was initiated with an initiator for cationic polymerizations and finished after 5 minutes. The obtained raw material was grinded and hydrolyzed at 170° C. in 4 liter of n-Methyl-2-pyrrolidon (NMP) to which has been added 4 ml of Triethylamine (TEA). After one hour, the system was allowed to cool down to room temperature again whereat the long-chain branched POM-PDMS precipitates. Afterwards the product was filtered and washed three times each with 200 ml of methanol and finally dried at 60° C. and nitrogen atmosphere.

The testing of the produced polymers was performed according to the following standards:
MVR (190° C., 2.16 kg and 15.0 kg): ISO 1133.
Incorporation rates were determined by NMR on a Varian 400 MHz-Spectrometer and a Bruker 400 MHz-Spectrometer using d-HFiP as solvent.
Thermal data (melting point, onset and crystallization point) have been determined with Differential Scanning Calorimetry (DSC, TA Instruments, Q200); heating rate 10K/min. according to ISO 11357-1, -2, -3.
GPC measurements were done on a SunChrom Sun Flow 100 device using hexafluoroisopropanol as eluent and two PSS-PFG columns (8×300 mm, 100 Å+1000 Å), detector Agilent 1200 RI-detector.
Polymer samples were compounded on a DSM Microl 5 compounder at 190° C. Torque was determined after 5 minutes and compared with commercial grades Delrin 100 and M15HP measured under same conditions: Delrin 100 has a torque of 6300 N and M15HP a torque of 6100 N.
Tensile bars were produced on a DSM Micro 10 cc device.
Tensile Modulus, Tensile Yield Stress, Tensile Stress at Break, Elongation at Yield, Elongation at Break were determined according to ISO 527.
Charpy Notched Impact Strengths were measured at 23° C. and at −30° C. according to ISO 179-1/1eA (CNI).
Tribology 1 tests were conducted on a Ziegler Instruments device according VDA 230-206. A ball-on-plate configuration was utilized with a load of 5-30 N, sliding speed of 1-8 mm/s. The ball consists of C9021.
Tribology 2 tests were conducted on an Anton Parr Instrument MCR 201 device. A ball-on-prism configuration was utilized with a load of 5 N, sliding speed of 100 mm/s. The ball consists of polished steel.

The siloxane monomer used had the following general formula:

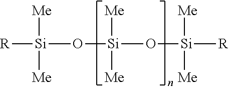

Two different PDMS samples have been used and nine different POM-PDMS samples have been made according to the present disclosure. The following are the reactants and the reaction conditions:

TABLE 1

| PDMS System | | | |
|---|---|---|---|
| | PDMS End | Dioxolane | PDMS |

| Example | | n | Group R | (DO) [%] | [%] | Initiator | T [°C.] |
|---|---|---|---|---|---|---|---|
| 1 | POM-PDMS₅₀ | 50 | 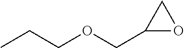 | 3.4 | 2.5 | Tnfluoromethane- sulfonic acid | 100 |
| 2 | POM-PDMS₂₀₀ | 200 | 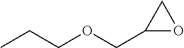 | 3.4 | 5.0 | Trifluoromethane- sulfonic acid | 100 |
| 3 | POM-PDMS₅₀ | 50 | 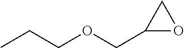 | 0.7 | 2.5 | Tungstophosphoric Acid | 100 |
| 4 | POM-PDMS₅₀ | 50 | 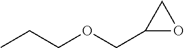 | 0.7 | 5.0 | Tungstophosphoric Acid | 100 |
| 5 | POM-PDMS₅₀ | 50 | 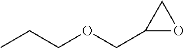 | 1.0 | 2.5 | Tungstophosphoric Acid | 100 |
| 6 | POM-PDMS₅₀ | 50 | 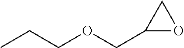 | 1.5 | 2.5 | Tungstophosphoric Acid | 100 |
| 7 | POM-PDMS₅₀ | 50 | 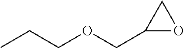 | 1.5 | 5.0 | Tungstophosphoric Acid | 100 |
| 8 | POM-PDMS₅₀ | 50 | 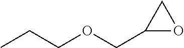 | 3.4 | 2.5 | Tungstophosphoric Acid | 100 |
| 9 | POM-PDMS₅₀ | 50 | 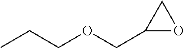 | 3.4 | 5.0 | Tungstophosphoric Acid | 100 |

The following results were obtained:

TABLE 2

| | | | | Examples | | | | |
|---|---|---|---|---|---|---|---|---|
| | | | | 1 | 2 | 3 | 4 | 5 |
| | | | | POM- | POM- | POM- | POM- | POM- |
| | Properties | Unit | Test method | POMS₅₀ | PDMS₂₀₀ | PDMS₅₀ | PDMS₅₀ | PDMS₅₀ |
| PDMS Content | Incorporated PDMS | % | / | 63 | 77 | 96 | 96 | 92 |
| | Incorporated PDMS | % | | 1.6 | 3.9 | 2.4 | 4.8 | 2.3 |
| Molecular | M_{w} | g/mol | / | 180.080 | 181.160 | 249.086 | 221.881 | 302.451 |
| Weight | Mₙ | g/mol | | 28.157 | 23.590 | 61.652 | 55.044 | 67.739 |
| | PD | | | 6.4 | 7.7 | 4.0 | 4.0 | 4.5 |
| Melt Viscosity | MVR 190/2.16 kg | ml/10 min | ISO 1133 | 1 | 2 | 0.2 | 0.2 | 0.2 |
| | MVR 190/15 kg | ml/10 min | ISO 1133 | 18 | 129 | 27 | 51 | 15 |
| Shear Thinning | Torque | N | OSM Micro 15 | 2.700 | 1.300 | 3.800 | 2.500 | 3.900 |
| Thermal | Melting Point [° C.] | ° C. | ISO 11357-1/-3 | 168 | 167 | 174 | 174 | 174 |
| | Onset [° C.] | ° C. | ISO 11357-1/-3 | 149 | 149 | 154 | 155 | 154 |
| | Crystallization Point [° C.] | ° C. | ISO 11357-1/-3 | 148 | 148 | 152 | 153 | 152 |
| Mechanics | Tensile Modulus | MPa | ISO 527 | 2747 | 2405 | 3319 | 3141 | 3084 |
| | Tensile Stress at Break | MPa | ISO 527 | 61 | 46 | 58 | 59 | 66 |
| | Elongation at Break | % | ISO 527 | 37 | 12 | 29 | 29 | 30 |
| | Notched Impact Strength | kJ/m² | ISO 179-1/1eA | 14 | 7 | 19 | 21 | 19 |
| | (Charpy, 23° C.) | | | | | | | |
| | Notched Impact Strength | kJ/m² | ISO 179-1/1eA | 12 | 6 | 15 | 15 | 15 |
| | (Charpy, −30° C.) | | | | | | | |
| Tribology 1 | Coefficient of Friction | (F = 30N, | VDA 230-206 | 0.09 | 0.05 | 0.17 | 0.08 | 0.19 |
| | (vs. C9021) | v = 8 mm/s, | | | | | | |
| | | t = 45 min) | | | | | | |
| | Wear (Ball, C9021) | mm | | 0.20 | 0.06 | 1.21 | 1.04 | 1.08 |
| Tribology 2 | Coefficient of Friction | (F = 5N, | / | n.a. | n.a. | 0.56 | 0.50 | 0.50 |
| | (vs. Steel Ball) | v = 100 mm/s, | | | | | | |
| | | t = 60 min) | | | | | | |
| | Wear (Ball, C9021) | mm | | n.a. | n.a. | 15.90 | 8.80 | 15.00 |

| | | | | Examples | | | |
|---|---|---|---|---|---|---|---|
| | | | | 6 | 7 | 8 | 9 |
| | | | | POM- | POM- | POM- | POM- |
| | Properties | Unit | Test method | PDMS₅₀ | PDMS₅₀ | PDMS₅₀ | PDMS₅₀ |
| PDMS Content | Incorporated PDMS | % | / | 84 | 92 | 88 | 95 |
| | Incorporated PDMS | % | | 2.1 | 4.6 | 2.2 | 4.7 |
| Molecular | M_{w} | g/mol | / | 236.293 | 217.188 | 201.590 | 234.244 |
| Weight | Mₙ | g/mol | | 62.093 | 53.421 | 63.755 | 65.048 |
| | PD | | | 3.8 | 4.1 | 3.2 | 3.6 |
| Melt Viscosity | MVR 190/2.16 kg | ml/10 min | ISO 1133 | 1.2 | 1.1 | 1.7 | 0.3 |
| | MVR 190/15 kg | ml/10 min | ISO 1133 | 58 | 69 | 50 | 55 |
| Shear Thinning | Torque | N | OSM Micro 15 | 2.800 | 1.900 | 2.700 | 2.300 |
| Thermal | Melting Point [° C.] | ° C. | ISO 11357-1/-3 | 173 | 172 | 168 | 168 |
| | Onset [° C.] | ° C. | ISO 11357-1/-3 | 153 | 154 | 151 | 151 |
| | Crystallization Point [° C.] | ° C. | ISO 11357-1/-3 | 151 | 152 | 149 | 149 |
| Mechanics | Tensile Modulus | MPa | ISO 527 | 2600 | 2500 | 2400 | 2200 |
| | Tensile Stress at Break | MPa | ISO 527 | 64 | 57 | 58 | 51 |
| | Elongation at Break | % | ISO 527 | 38 | 22 | 44 | 44 |
| | Notched Impact Strength | kJ/m² | ISO 179-1/1eA | 12 | 14 | 13 | 16 |
| | (Charpy, 23° C.) | | | | | | |
| | Notched Impact Strength | kJ/m² | ISO 179-1/1eA | 11 | 13 | 11 | 13 |
| | (Charpy, −30° C.) | | | | | | |
| Tribology 1 | Coefficient of Friction | (F = 30N, | VDA 230-206 | 0.24 | 0.17 | 0.30 | 0.09 |
| | (vs. C9021) | v = 8 mm/s, | | | | | |
| | | t = 45 min) | | | | | |
| | Wear (Ball, C9021) | mm | | 1.36 | 1.09 | 1.50 | 0.28 |
| Tribology 2 | Coefficient of Friction | (F = 5N, | / | 0.46 | 0.41 | 0.46 | 0.27 |
| | (vs. Steel Ball) | v = 100 mm/s, | | | | | |
| | | t = 60 min) | | | | | |
| | Wear (Ball, C9021) | mm | | 17.10 | 14.50 | 15.00 | 12.90 |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A polyoxymethylene polymer composition comprising a branched polyoxymethylene-polydimethylsiloxane copolymer having the following structure: 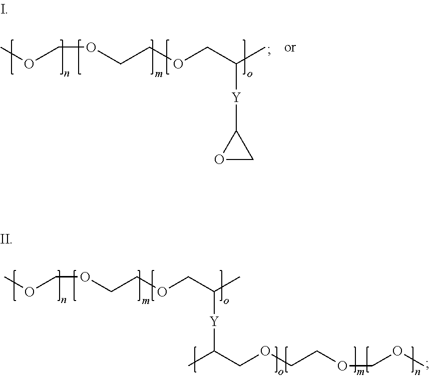
III. or mixtures of I and II
wherein m is from 2 to 40, n is from 5 to 2500, and o is from 1 to 150, and wherein Y has the following structure: 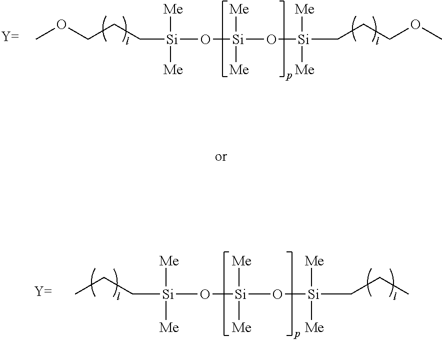
and wherein l is from 1 to 100 and p is greater than m and is from 10 to 1,000.

2. A polyoxymethylene polymer composition as defined in claim 1, wherein the polyoxymethylene polymer composition is further blended with another polyoxymethylene polymer.

3. A polyoxymethylene polymer composition as defined in claim 2, wherein the other polyoxymethylene polymer comprises an unbranched polyoxymethylene-polydimethylsiloxane block copolymer containing polyoxymethylene blocks and polysiloxane blocks, such as polydialkylsiloxane blocks.

4. A polyoxymethylene polymer composition as defined in claim 3, wherein the polysiloxane blocks are polyalkylene oxide terminated.

5. A polyoxymethylene polymer composition as defined in claim 2, wherein the block copolymer includes polyoxymethylene polymer blocks separated by the polysiloxane blocks.

6. A polyoxymethylene polymer composition as defined in claim 2, wherein the polyoxymethylene-polydimethylsiloxane copolymers are present in the composition at a weight ratio to the block copolymers at a range from about 1:10 to about 10:1.

7. A polyoxymethylene polymer composition as defined in claim 1, wherein the polyoxymethylene-polydimethylsiloxane copolymers exhibit a dynamic coefficient of friction against a POM reference material of less than 0.35 when tested according to VDA 230-206 at a force of 30 N, a velocity of 8 mm/s, and for a time of 45 minutes.

8. A polyoxymethylene polymer composition as defined in claim 1, wherein the polyoxymethylene-polydimethylsiloxane copolymers exhibit a wear according to VDA 230-206 of less than 2.0 mm.

9. A polyoxymethylene polymer composition as defined in claim 1, wherein the polyoxymethylene-polydimethylsiloxane copolymers contain a greater amount of Formula I than Formula II.

10. A polyoxymethylene polymer composition as defined in claim 1, wherein the polyoxymethylene-polydimethylsiloxane copolymers contain the structure provided by Formula I in an amount greater than 60% by weight.

11. A polyoxymethylene polymer composition as defined in claim 1, wherein the polyoxymethylene-polydimethylsiloxane copolymers contain the structure provided by Formula I in an amount greater than 70% by weight.

12. A polyoxymethylene polymer composition as defined in claim 1, wherein the polyoxymethylene-polydimethylsiloxane copolymers contain the structure provided by Formula I in an amount greater than 80% by weight.

13. A polyoxymethylene polymer composition as defined in claim 1, wherein the polyoxymethylene-polydimethylsiloxane copolymers exhibit a Charpy notched impact strength at −30° C. of greater than 15 kJ/m² and a Charpy notched impact strength at 23° C. of greater than 20 kJ/m² when tested according to ISO Test 179-1/1eA.

14. A polyoxymethylene polymer composition as defined in claim 1, wherein the polyoxymethylene-polydimethylsiloxane copolymers have a melt volume flow rate of less than 10 ml/10 min when tested according to ISO Test 1133 at 190° C. and at a load of 2.16 kg.

15. A polyoxymethylene polymer composition as defined in claim 1, wherein the polyoxymethylene-polydimethylsiloxane copolymers have a torque of greater than about 1,000 N when tested with DSM Micro 15.

16. A polyoxymethylene polymer composition as defined in claim 1, wherein the polyoxymethylene-polydimethylsiloxane copolymers have an induction period at its cloud point of less than 5 min.

17. A polyoxymethylene polymer composition as defined in claim 1, wherein the polyoxymethylene-polydimethylsiloxane copolymer contains dioxolane units in an amount greater than 0 mol % and up to about 50 mol %.

18. A process for producing polyoxymethylene copolymers comprising:
reacting a monomer comprising trioxane with a α,ω-epoxy terminated polydimethylsiloxane in the presence of an initiator, the initiator comprising an acid that is boron free to produce at least one polyoxymethylene copolymer containing polydimethylsiloxane units.

19. A process as defined in claim 18, wherein the α,ω-epoxy terminated polydimethylsiloxane has the following structures: 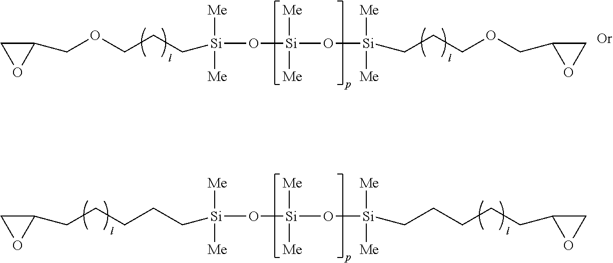
wherein l is from 1 to 100 and p is from 10 to 1,000.

20. A process as defined in claim 18, wherein the reaction produces polyoxymethylene copolymers having the following structures: 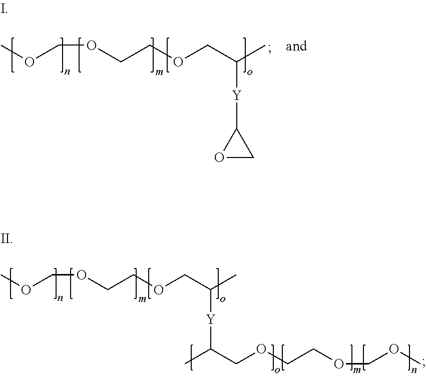
III. or mixtures of I and II
wherein m is from 2 to 10, n is from 5 to 1,500, and o is from 1 to 150, and wherein Y has the following structures: 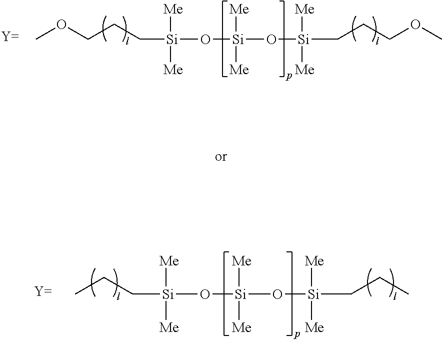
and wherein l is from 1 to 100 and p is greater than m and is from 10 to 1,000.
